(19) United States
(12) Patent Application Publication
(10) Pub. No.: US 2017/0335907 A1
(43) Pub. Date: Nov. 23, 2017

(54) Hydraulic Circuit and Method for Controlling a Hydraulic Circuit

(71) Applicant: AVL COMMERCIAL DRIVELINE & TRACTOR ENGINEERING GMBH, STEYR (AT)

(72) Inventors: STEFAN KUNTNER, ASTEN (AT); GEBHARD WÖNTNER, WOLFERN (AT); UDO KNEITZ, STEYR (AT); ROLAND HINTRINGER, LINZ (AT); DAVID WINKLER, LAAKIRCHEN (AT)

(73) Assignee: AVL COMMERCIAL DRIVELINE & TRACTOR ENGINEERING GMBH, STEYR (AT)

(21) Appl. No.: 15/522,134

(22) PCT Filed: Oct. 22, 2015
(86) PCT No.: PCT/EP2015/074458

§ 371 Date: Apr. 26, 2017

(30) Foreign Application Priority Data
Oct. 27, 2014 (AT) A 50771/2014

(51) Int. Cl. F16D 48/06; F16D 48/02; F16D 25/10; F16D 25/12

(52) U.S. Cl. CPC F16D 48/066; F16D 25/12; F16D 25/14; F16D 48/0206; F16D 48/062; F16D 25/10; F16D 2048/0269; F16D 2048/0203; F16D 2048/0278; F16D 2048/0281; F16D 2500/3022; F16D 2500/3024; F16D 2500/5108; F16D 2048/0221

(57) ABSTRACT

The invention relates to a hydraulic circuit (1) of a torque transmission device, wherein at least two, in particular closed in a non-actuated state (normally closed), clutches (2, 3) of the torque transmission device can be element (12, 13) of the hydraulic circuit, wherein in a clutch opening state, every clutch valve element (12, 13) is connected to a high-pressure line (30) that is applied with the pressure of a high-pressure hydraulic accumulator (31) and/or generator (32), by means of a pressurisation line (22, 23) for the deflection of the clutch (2, 3), and in a closing state, same is connected to a low-pressure tank (40) by means of a tank line (42, 43, 44, 45, 46, 47, 48, 49) for releasing a deflection pressure, and wherein the tank lines (42, 43, 44, 45, 46, 47, 48, 49) of the clutch valve elements (12, 33) are guided to a safety valve (50), in particular by means of a common collection tank line (41), which safety valve can be switched in such a way that the tank lines (42, 43, 44, 45, 46, 47, 48, 49) can be applied with the pressure of the high-pressure line (30).

The invention relates to a hydraulic circuit of a torque transmission device and to a torque transmission device having at least two “normally closed” clutches and such a hydraulic circuit.

Known dual-clutch transmissions for motor vehicles are formed in such a way that at least one of the two clutches is open in the non-actuated state (i.e. “normally open” or spring-to-open), so that during a hydraulic and/or electric fault or failure at least this clutch opens mechanically and a secure state is thus achieved.

As a consequence, hydraulic and/or electrical power must be applied continuously in the operating state at least in this clutch formed in a normally open manner, i.e. for closing said clutch and keeping it closed, in order to ensure adequate torque transmission by the dual-clutch transmission. This input of power decreases the efficiency of such transmissions because power needs to be applied continuously for keeping the “normally open” clutch closed.

Measures are known from the publications DE 10 2010 044 280 A1, WO 2007/104276 A1, WO 2008/055464 A2, WO 03/074909 A2 and DE 100 44 493 A1 in order to transfer a dual-clutch transmission to a secure state in the event of a fault. These known solutions are comparatively complex and require a relatively large amount of overall space.

It is an object of the invention to provide a hydraulic circuit of a torque transmission device and a method for controlling a hydraulic circuit with which operation of the torque transmission device is possible with high efficiency.

This object is achieved by a hydraulic circuit with the features of claim 1 and a method for controlling a hydraulic circuit with the features of claim 9. A torque transmission device with such a hydraulic circuit is protected in claim 8. Advantageous further developments of the invention are the subject matter of the dependent claims.

According to one aspect of the invention, a hydraulic circuit of a torque transmission device, especially of a motor vehicle, is proposed in which at least two, in particular closed in a non-actuated state (normally closed), clutches of the torque transmission device can be switched by means of a respective hydraulic clutch valve element of the hydraulic circuit. In this process, every clutch valve element, in a clutch opening state, is connected to a high-pressure line that is applied with the pressure of a high-pressure hydraulic accumulator and/or generator by means of a pressurisation line for the deflection of the clutch and, in a closing state, to a low-pressure tank by means of a tank line for releasing a deflection pressure. In accordance with the invention, the tank lines of the clutch valve elements are especially guided via a common collection tank line to a safety valve, which can be switched in such a way that the tank lines can be applied with the pressure of the high-pressure line.

As a result, an adequately high pressure level can be maintained in the tank lines of the clutch valve elements in the event of hydraulic or electrical failure of the hydraulic circuit in order to prevent undesirable closure of a “normally closed” clutch of the torque transmission device, which can enable the use of such clutches. This applies especially to a hydraulic fault in a pressurisation line or for electrical faults which lead to the consequence that the predetermined pressurisation of the various valve elements is no longer functional.

In comparison with known hydraulic circuits, the length of the installed hydraulic lines can further be reduced by combining several individually formed tank lines into a collection tank line, which can make the planning and mounting of the hydraulic circuit easier and its operation less susceptible to faults.

According to an advantageous further development, the hydraulic circuit in accordance with the invention comprises at least one primary switching group with an idle position, a first and second switching position, wherein the primary switching group can be switched by means of a first hydraulic switching valve element to the first switching position and by means of a second hydraulic switching valve element to the second switching position, and wherein each of the switching valve elements is connected in a switching state by means of a pressurisation line for deflection to a switching position of the switching group to the high-pressure line and in a non-switching state by means of a tank line for releasing a switching pressure to the low-pressure tank. The tank lines of the first and the second hydraulic switching valve elements of the primary switching group are thus guided especially by means of a common collection tank line and/or together with the tank lines of the clutch valve elements to the safety valve.

Such switching groups are especially designated as primary switching groups in this case, which need to be situated in an idle position in order to achieve substantial resistance-free towing, coasting and/or a decoupling of the torque transmission device and/or a drive device of the motor vehicle from the driven wheels of the vehicle.

It can be ensured by forming the hydraulic circuit according to this further development that all primary switching groups installed in the torque transmission device can be switched in the event of hydraulic or electrical failure in such a way that the vehicle train on the wheel side is decoupled to the highest possible extent from the primary and optionally secondary switching groups of the torque transmission device. This can contribute for example to the minimisation of a towing resistance or to providing a secure driving state during coasting of the vehicle after a defect of the hydraulic circuit.

According to a further advantageous further development, the hydraulic circuit in accordance with the invention comprises at least one secondary switching group with an idle position and at least one first switching position, wherein the secondary switching group can be switched to the first switching position by means of at least one hydraulic switching valve element. In doing so, said switching valve element is connected in one switching state by means of a pressurisation line to the high-pressure line. In a non-switching state, said switching valve element is connected by means of a tank line that is guided past the safety valve to a low-pressure tank, which enables a smaller configuration of the safety valve.

Such switching groups are designated in the present case as secondary switching groups which are only included in the torque flow of the torque transmission device depending on a switching position of at least one primary switching group.

The hydraulic circuit preferably comprises substantially only one single low-pressure tank in which the hydraulic fluid can be collected, which is guided through and past the safety valve, and which low-pressure tank is connected to a hydraulic pump by means of which hydraulic fluid is taken from the low-pressure tank, subjected to high pressure and stored in a high-pressure hydraulic accumulator.

According to a further advantageous further development, the hydraulic circuit additionally comprises a sensor device for monitoring a functional state of the hydraulic circuit and a control device for triggering the safety valve. The control device is preferably designed to trigger the safety valve on the basis of a detection of a malfunction state of the hydraulic circuit in such a way that the joined tank lines and/or the collection tank line is subjected to the pressure of the high-pressure line. If the sensor device therefore detects a hydraulic or electrical failure, i.e. a malfunction state, the switching of the safety valve is changed in such a way that the pressure of the high-pressure line is no longer applied to the pressurisation lines jointly guided through the safety valve, but now preferably to the collection tank line or the tank lines jointly guided to the safety valve. It can thus be ensured that directly after the occurrence of a malfunction the substantial decoupling of drive device, torque transmission device and/or wheel-side components of the drive train occurs, which can allow secure coasting of the motor vehicle among other things.

The clutch and/or switching valve elements are also preferably switched in the switching of the safety valve for applying high-pressure hydraulic fluid to tank lines in such a way that a fluid connection is produced between a tank connection and an actuating connection of the respective valve element, wherein especially preferably a pressurisation connection is decoupled from the fluid connection.

According to a further advantageous further development of the hydraulic circuit in accordance with the invention, the sensor device comprises at least one pressure sensor for monitoring a hydraulic functional state of the hydraulic circuit and/or at least one voltage or current sensor for monitoring a functional control state. It can thus be ensured that secure coasting or towing is enabled both during the occurrence of faults in the hydraulic circuit caused by wear and tear or mounting, especially in the pressurisation lines, and also during the occurrence of electronic faults in the control of the hydraulic circuit.

According to a further advantageous further development of the hydraulic circuit in accordance with the invention, the safety valve is formed in such a way that in a currentless operating state, which is especially not predetermined, the high-pressure line and the joined tank lines or the collection tank line are switched with respect to each other in hydraulic communication. This switching is provided by the control device, which can enable a “failsafe mode” by switching over the hydraulic high-pressure from the pressurisation lines to the tank lines.

According to a further advantageous further development of the hydraulic circuit in accordance with the invention, the safety valve is designed in such a way that during a pressurisation of the tank lines with the pressure of the high-pressure line the pressurisation lines are decoupled from this pressure, as a result of which a “pressure deadlock” is avoided, in which the switching states and clutch states that are set during the occurrence of the failure or defect cannot be released by applying high-pressure to all lines.

According to a further aspect of the invention, a torque transmission device is proposed having at least two clutches especially formed in a “normally closed” manner and at least one primary switching group with an idle position, a first and a second switching position. The torque transmission device comprises a hydraulic circuit according to an embodiment of the invention.

According to a further aspect of the invention, a method is proposed for controlling a hydraulic circuit of a torque transmission device according to one of the preceding claims. A malfunction of the hydraulic circuit is detected thereby. The tank lines of at least one clutch and the primary switching groups of the torque transmission device are subjected to the pressure of the high-pressure line by means of a safety valve.

According to a further development of the method, a hydraulic malfunction is detected, especially by means of a pressure sensor, and/or an electrical malfunction, especially by means of a voltage or current sensor. The safety valve is subsequently switched by means of the control device.

According to a further development of the method, the safety valve is switched following a failure of the electrical system.

Further exemplary embodiments of the invention will be explained below in closer detail by reference to the drawings and the associated description, wherein the drawings show the following in detail, at least partly in a schematic manner:

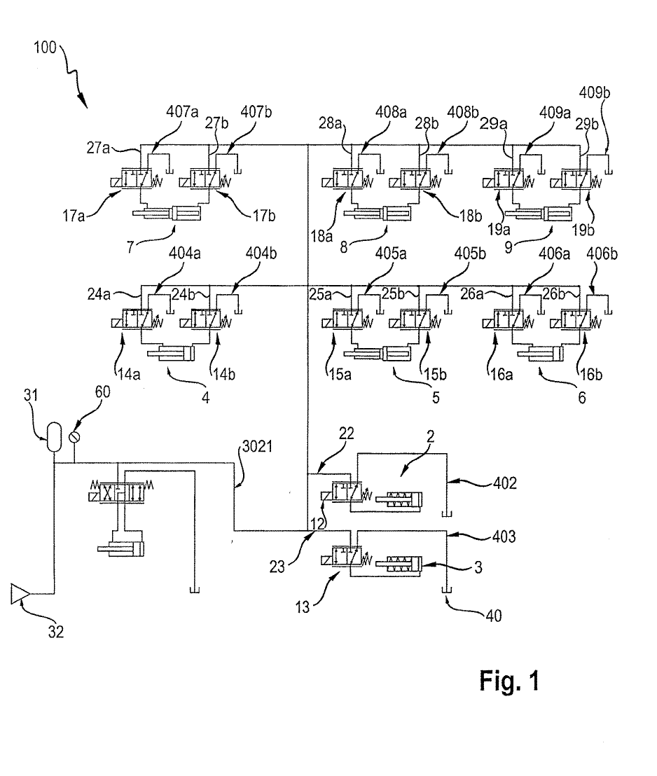

FIG. 1 shows a hydraulic circuit of a torque transmission device of a motor vehicle with two clutches, two primary switching groups and four secondary switching groups according to the prior art in a circuit diagram illustration;

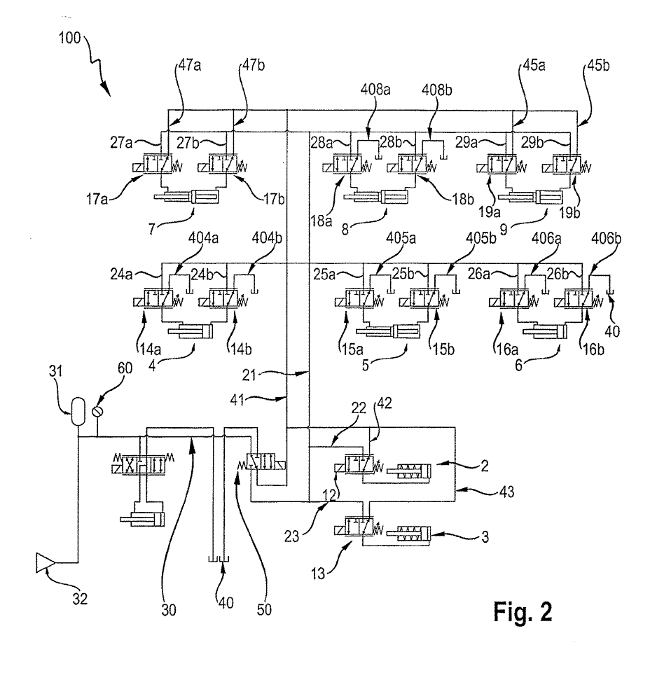

FIG. 2 shows a hydraulic circuit according to an embodiment of the invention for a torque transmission device as in FIG. 1 in a circuit diagram illustration, and

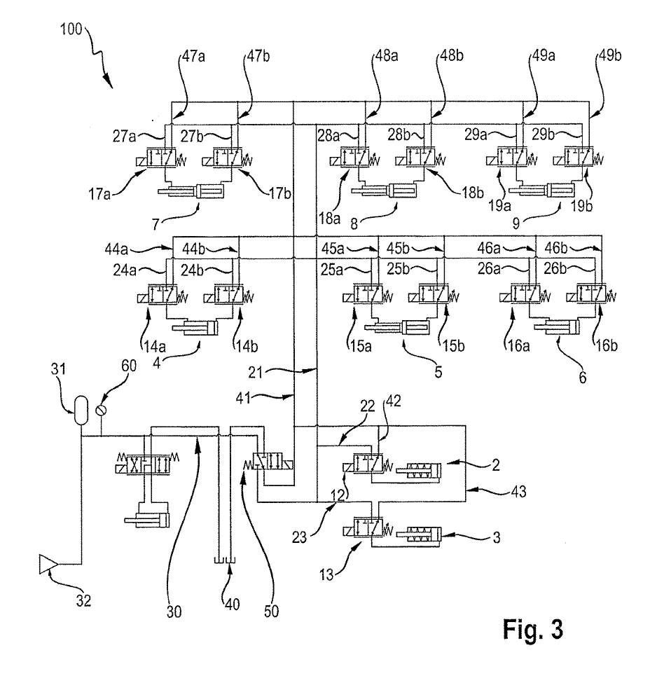

FIG. 3 shows a hydraulic circuit according to a further embodiment of the invention for a torque transmission device as in FIG. 1 in a circuit diagram illustration.

FIG. 1 to FIG. 3 each show a hydraulic circuit 1 or 100 for a generally identical torque transmission device of a motor vehicle, which torque transmission device is formed as a dual-clutch transmission and comprises two clutches 2 and 3, a primary switching group 7 for switching a switching stage of a planetary gear set, a primary switching group 9 formed as a double spur gear stage, three secondary switching groups 5, 6 and 8 formed as double spur gear stages, and a secondary switching group 4 formed as a shaft connection stage, as well as a parking brake which is not provided with a reference numeral.

FIG. 1 shows an embodiment of a hydraulic circuit 100 which is known from the prior art. Conventional hydraulic circuits 100 for torque transmission devices in motor vehicles are formed in such a way that the tank lines 402 to 409 are connected directly to the low-pressure reservoir or low-pressure tank 40 of the hydraulic circuit 100 for reducing a previous pressurisation. The low-pressure tank 40 is used as a hydraulic fluid reservoir for the pump 32, which provides a high-pressure hydraulic fluid in the hydraulic circuit 100, which can be stored in the high-pressure hydraulic accumulator 31.

The hydraulic circuit 100 of FIG. 1 actuates a “normally open” clutch 2 and a “normally closed” clutch 3 with a respective hydraulic valve element 12 or 13. Furthermore, the hydraulic circuit 100 actuates two primary spur gear switching groups 7 and 9 and the secondary switching groups 4, 5, 6 and 8.

Each of the clutches 2 and 3 is switched by a clutch valve element 12 or 13. The switching groups 4, 5, 6, 7, 8, 9 are respectively switched by two switching valve elements 14a/b, 15a/b, 16a/b, 17a/b, 18a/b, 19a/b.

Each of the switching elements 12 to 19b has an actuator output, which is pressurised with the pressure of the high-pressure accumulator 31 for the desired deflection, for opening the clutch or for switching the desired switching state. Said pressurisation occurs via the high-pressure line 3021, which is split into the pressurisation lines 22 to 29b without valves interposed in the line. The pressurisation lines 22 to 29b are respectively guided to a pressurisation connection P of the valve elements 12 to 19b, where a high pressure is thus applied. In the event of a respective (through) switching of one of the valve elements 12 to 19b, the high pressure applied to the pressurisation connection P is transmitted to the actuating connection A and the respective component of the transmission is thus switched.

In order to reduce the pressure applied to a clutch 2, 3 or one of the switching groups 4 to 9 for deflecting the associated hydraulic piston, the respective valve element 12 to 19b is switched in such a way that the respective actuating connection A is connected to a tank connection T of the respective valve element 12 to 19b. The tank connection T of each of the valve elements 12 to 19b is connected via a separate tank line 402 to 409b to the low-pressure tank 40 of the hydraulic circuit 100, so that a simple pressure reduction can occur via said discharge line on the transmission component (e.g. clutch or switching group) switched by means of the respective valve element 12 to 19b. The clutches 2, 3 can be brought to a closed state again by the pressure reduction and the switching elements to a state free from hydraulic forces, which allows switching to a different switching state.

If a pressure reduction occurs in such an embodiment of a known hydraulic circuit 100 in the pressurisation connections of the valve elements 12 to 19b as a result of a failure in the electrical control, in the high-pressure line 3021 and/or in one of the pressurisation lines 22 to 29b, there is no possibility to maintain the high pressure on said valve elements.

This means in an embodiment with two “normally closed” clutches that these two clutches close immediately, which can lead to dangerous driving situations in a moved vehicle. Furthermore, such a vehicle can usually only be towed by loading on a trailer. That is why vehicles with transmission devices with the described known hydraulic circuit are provided with at least one “normally open” clutch.

FIG. 2 shows a hydraulic circuit 1 according to the embodiment of the invention for the same transmission. It is based on the concept to provide a possibility by means of which a compensation possibility can be provided in the case of a hydraulic and/or electrical failure of the hydraulic circuit after a drop in the high-pressure level of the pressurisation connections P of the valve elements 12 to 19b, by means of which the high pressure can be maintained at the output connections A of the valve elements 12 to 19b despite the defect.

For this purpose, a safety valve 50 is provided in the hydraulic circuit 1 between the high-pressure pump 32 and the high-pressure hydraulic accumulator 31 on the one hand and the clutch valve elements 12, 13 and the switching valve elements 14a to 19b on the other hand. The high-pressure line 30 is connected to said safety valve 50 and a connecting line to the low-pressure tank 40 on the one hand.

On the other hand, a common pressurisation line 21 which is connected to the pressurisation lines 22 to 29b is connected as well as the collection tank line 41 which in this embodiment is connected to the individual tank lines 42 and 43 of the two clutch valve elements 12 and 13 as well as the individual tank lines 47a, 47b, 49a and 49b of the two primary switching groups 7 and 9. The secondary switching groups 4, 5, 6 and 8 are connected in this embodiment by the conventional separate tank lines 404, 405, 406 and 408 to the low-pressure tank 40.

In the normal operating case of the hydraulic circuit 1, the pressure of the high-pressure lines is directly switched through to the common pressurisation line 21 in the safety valve 50. The collection tank line 41 is connected in this normal operating case in the safety valve 50 directly to the connecting line to the low-pressure tank 40.

In this manner, each of the valve elements 12 to 19b can be supplied with high pressure from the high-pressure hydraulic accumulator 31 according to predetermined switching by the control device, as a result of which the associated transmission components 2 to 9 can be switched as desired. Similarly, the pressure drop switched by means of the control device on a valve element 12, 13, 17 or 19 connected to the safety valve 50 can occur by means of their tank lines.

The guidance of the discharged hydraulic fluid via the collection tank line 41 to the safety valve 50 now opens up the additional possibility to pressurise the collection tank line 41 by means of a changeover of the safety valve 50 with the high pressure applied to the high-pressure hydraulic accumulator 31 and to thus maintain said high pressure in the desired primary valve elements 12, 13, 17 and 19, while simultaneously the secondary valve elements 14 to 16 and 18 are disconnected from the high pressure.

This prevents any uncontrolled drop in the switching pressure in the clutches 2 and 3 and the primary switching groups 7 and 9 in the event of a hydraulic failure, e.g. in one of the pressurisation lines 21 to 29b, which would lead to unsafe driving states and/or adverse towing capability of the vehicle. Instead, the high pressure from the high-pressure hydraulic accumulator 31 is now applied to the clutches 2 in 3, as a result of which they become or remain open.

The high-pressure from the high-pressure hydraulic accumulator 31 is applied to the primary switching groups 7 and 9 in both switching valve elements, through which they can be moved to the desired neutral switching position. A decoupling of the wheels of the vehicle from its drive is possible by opening the clutches 2 and/or 3 in this case. As a result, two “normally closed” clutches can be installed which improve the efficiency of the dual-clutch transmission and are closed in the non-actuated state.

By shifting the primary switching groups 7 and 9 to a neutral switching position or idle position, preferably the secondary switching groups can be decoupled from the drive train on the wheel side, so that they do not have to be co-moved in the event of towing for example.

FIG. 3 shows a further exemplary embodiment of a hydraulic circuit 1 in accordance with the invention. Whereas in the embodiment according to FIG. 2 only the tank lines of the clutch valve elements 12 and 13 as well as the tank lines 47, 49 of the switching valve elements 17 and 19 were guided via the safety valve, in the embodiment according to FIG. 3 this also occurs with the tank lines 44, 45, 46 and 48 of the switching valve groups 14, 15, 16 and 18 of the secondary switching groups 4, 5, 6 and 8.

The embodiment according to FIG. 3 is thus formed in a redundant manner, since not only the primary elements 2, 3, 7 and 9, which are necessary in order to achieve a secure driving state, are included in the hydraulic circuit 1 with the safety valve 50, but also the secondary elements 4, 5, 6 and 8, which in the event of the failure one of the primary elements 2, 3, 7 and 9 can replace them, which thus makes this system more failure-proof.

The embodiment according to FIG. 2 is reduced to the primary elements 2, 3, 7 and 9 and thus allows a compact safety valve 50 which can thus be purchased at low cost, as well as shorter hydraulic lines and a smaller high-pressure hydraulic accumulator 31, thus reducing the mounting work, purchase costs and overall size.

1-11. (cancel)

12. A hydraulic circuit, especially of a torque transmission device, comprising two hydraulic clutch valve elements which are each configured for switching at least two clutches of the torque transmission device, wherein each clutch valve element is connected in a clutch opening state by means of a pressurisation line for deflecting the clutch to a high-pressure line that is applied with the pressure of a high-pressure hydraulic accumulator and/or a generator, and is connected in a closed state to a low-pressure tank by means of a tank line for releasing a deflection pressure, wherein the tank lines of the clutch valve elements are guided to a safety valve, which safety valve can be switched in such a way that the tank lines can be applied with the pressure of the high-pressure line.

13. The hydraulic circuit according to claim 12, comprising at least one primary switching group with an idle position, a first and a second switching position, wherein the primary switching group can be switched by means of a first hydraulic switching valve element to the first switching position and by means of a second hydraulic switching valve element to the second switching position, wherein each of the switching valve elements is connected in one switching state to the high-pressure line by means of a pressurisation line for deflection to a switching position of the switching group, and in a non-switching state to the low-pressure tank by means of a tank line for releasing a switching pressure, wherein the tank lines of the first and the second hydraulic switching valve elements of the primary switching group are guided to the safety valve.

14. The hydraulic circuit according to claim 13, wherein the tank lines of the first and the second hydraulic switching valve elements of the primary switching group are guided to the safety valve by means of a common collection tank line and/or together with the tank lines of the clutch valve elements.

15. The hydraulic circuit according to claim 12, comprising at least one secondary switching group with an idle position and at least one first switching position, wherein the secondary switching group can be switched to the first switching position by means of at least one hydraulic switching valve element, wherein said switching valve element is connected in one switching state to the high-pressure line by means of a pressurisation line, and to a low-pressure tank in a non-switching state by means of a tank line which is guided past the safety valve.

16. The hydraulic circuit according to claim 12, wherein the hydraulic circuit additionally comprises a sensor device for monitoring a functional state of the hydraulic circuit, and a control device designed for triggering the safety valve, such that it triggers the safety valve on the basis of detecting a malfunction state of the hydraulic circuit in such a way that the joined tank lines are applied with the pressure of the high-pressure line.

17. The hydraulic circuit according to claim 16, wherein the sensor device comprises at least one pressure sensor for monitoring a hydraulic functional state of the hydraulic circuit and/or at least one voltage and/or current sensor for monitoring a functional control state.

18. The hydraulic circuit according to claim 12, wherein the safety valve is formed in such a way that in a currentless operating state the high-pressure line and the joined tank lines are switched with respect to each other in hydraulic communication.

19. The hydraulic circuit according to claim 18, wherein the currentless operating state is not predetermined.

20. The hydraulic circuit according to claim 12, wherein the safety valve is designed in such a way that during a pressurisation of the tank lines with the pressure of the high-pressure line the pressurisation lines are decoupled from this pressure.

21. The hydraulic circuit according to claim 12, wherein the two clutches are closed in a non-actuated state (normally closed).

22. The hydraulic circuit according to claim 12, wherein the tank lines of the clutch valve elements are guided to a safety valve by means of a common collection tank line.

23. A torque transmission device, comprising at least two clutches, especially formed as “normally closed”, and at least one primary switching group with an idle position, a first and a second switching position, with a hydraulic circuit according to claim 12.

24. A method for controlling a hydraulic circuit of a torque transmission device comprising two hydraulic clutch valve elements which are each configured for switching at least two clutches of the torque transmission device, wherein each clutch valve element is connected in a clutch opening state by means of a pressurisation line for deflecting the clutch to a high-pressure line that is applied with the pressure of a high-pressure hydraulic accumulator and/or a generator, and is connected in a closed state to a low-pressure tank by means of a tank line for releasing a deflection pressure, wherein the tank lines of the clutch valve elements are guided to a safety valve, which safety valve can be switched in such a way that the tank lines can be applied with the pressure of the high-pressure line, wherein
a malfunction of the hydraulic circuit is detected, and
by means of a safety valve the tank lines of at least one clutch and the primary switching groups of the torque transmission device are applied with the pressure of the high-pressure line.

25. The method according to claim 24, wherein a hydraulic malfunction is detected, especially by means of a pressure sensor, and/or an electrical malfunction, especially by means of a voltage or current sensor, and thereupon the safety valve is switched by means of the control device.

26. The method according to claim 25, wherein the hydraulic malfunction is detected by means of a pressure sensor.

27. The method according to claim 25, wherein the electrical malfunction is detected by means of a voltage or current sensor.

28. The method according to claim 24, wherein the safety valve is switched due to a failure of the electrical system.
